(19) United States
(12) Patent Application Publication
(10) Pub. No.: US 2024/0249026 A1
(43) Pub. Date: Jul. 25, 2024

(54) ANONYMIZATION APPARATUS, ANONYMIZATION METHOD AND PROGRAM

(71) Applicant: NIPPON TELEGRAPH AND TELEPHONE CORPORATION, Tokyo (JP)

(72) Inventor: Daiki MICHIHIRO, Tokyo (JP)

(73) Assignee: NIPPON TELEGRAPH AND TELEPHONE CORPORATION, Tokyo (JP)

(21) Appl. No.: 18/575,820

(22) PCT Filed: Jun. 30, 2021
(86) PCT No.: PCT/JP2021/024773

§ 371 Date: Dec. 30, 2023

(51) Int. Cl. G06F 21/62

(52) U.S. Cl. CPC G06F 21/6254

(57) ABSTRACT

Provided is an anonymization method that maintains the utility required for analysis without impairing the value of a movement history. An anonymization device includes a POI database storage unit that stores a polygon data set serving as a set of polygon data associated with facility name data and indicating a site of a certain facility including a parking lot, a point extraction unit that extracts movement history data inside a polygon included in the polygon data set from target movement history data, the movement history data being time-series data including location information and time and being acquired for a vehicle, a point facility combination unit that refers to the POI database storage unit to combine facility name data of polygon data including the extracted movement history data with the extracted movement history data, a location information deletion unit that deletes the location information of the movement history data combined with the facility name data, and an overlapping facility deletion unit that deletes the movement history data having overlapping facility names from the movement history data from which the location information has been deleted to obtain anonymized movement history data.

### TECHNICAL FIELD

The present invention relates to a technique for anonymizing movement history data while maintaining the utility in accordance with an analysis purpose.

### BACKGROUND ART

Anonymization is a data processing method of deleting or changing information that can identify an individual. As a security index of anonymization, k-anonymity is widely known. The index k-anonymity means “there are at least k records that share the same combination of values for the target attributes in a database”. Protection of privacy of location information is studied as location privacy-preserving mechanisms (LPPMs). There have been proposed a method of generalizing location information as a wider area by dividing space into grids so as to satisfy k-anonymity (refer to Non Patent Literature 1), a method of adding dummy data (refer to Non Patent Literature 2), and a method of adding noise so as to satisfy differential privacy (refer to Non Patent Literature 3).

### CITATION LIST

### Non Patent Literature

Non Patent Literature 1: Toshiro Hikita, Rie Yamaguchi, “Method for anonymizing trajectories using hierarchical encoding representation (in Japanese)”, DICOMO 2015 Non Patent Literature 2: J. Krumm, “Realistic driving trips for location privacy”, Pervasive, 2009, vol. 5538, pp. 25-41.

Non Patent Literature 3: M. E. Andres, N. E. Bordenabe, K. Chatzikokolakis, and C. Palamidessi, “Geo-indistinguishability: Differential Privacy for Location-based Systems”, CCS, 2013, pp. 901-914.

### SUMMARY OF INVENTION

### Technical Problem

Since location information is highly private and high-dimensional data, the information has a so-called “the curse of dimensionality” problem, in which strong processing is required and the utility is lost. In particular, the conventional art has a problem in which, in a case where one wants to know a point of interest (POI) of an individual user, the POI information is lost. There is a demand for an anonymization method that maintains the utility required for analysis without impairing the value of a movement history.

An object of the present invention is to provide an anonymization method that maintains utility required for analysis without impairing the value of a movement history.

### Solution to Problem

In order to solve the above problem, according to an aspect of the present invention, an anonymization device includes a POI database storage unit that stores a polygon data set serving as a set of polygon data associated with facility name data and indicating a site of a certain facility including a parking lot, a point extraction unit that extracts movement history data inside a polygon included in the polygon data set from target movement history data, the movement history data being time-series data including location information and time and being acquired for a vehicle, a point facility combination unit that refers to the POI database storage unit to combine facility name data of polygon data including the extracted movement history data with the extracted movement history data, a location information deletion unit that deletes the location information of the movement history data combined with the facility name data, and an overlapping facility deletion unit that deletes the movement history data having overlapping facility names from the movement history data from which the location information has been deleted to obtain anonymized movement history data.

### Advantageous Effects of Invention

The present invention exerts an effect of being able to anonymize a movement history while maintaining the utility required for analysis without impairing the value of the movement history.

### BRIEF DESCRIPTION OF DRAWINGS

FIG. 1 is a diagram for describing an overview of the present embodiment.

FIG. 2 is a diagram for describing anonymization and synthesis of a pseudo route.

FIG. 3 is a functional block diagram of an anonymization device according to the first embodiment.

FIG. 4 is a diagram illustrating a processing flow of the anonymization device according to the first embodiment.

FIG. 5 is a diagram illustrating examples of movement history data and anonymized movement history data.

FIG. 6 is a diagram illustrating an example of movement history data.

FIG. 7 is a diagram illustrating an example of a polygon data set.

FIG. 8 is a diagram for describing the procedure of extracting movement history data inside a polygon included in the polygon data set.

FIG. 9 is a diagram for describing an example of extraction and deletion from movement history data taken out from a movement history database storage unit.

FIG. 10 is a diagram illustrating an example of data output from a point facility combination unit.

FIG. 11 is a diagram illustrating an example of data output from a location information deletion unit.

FIG. 12 is a diagram illustrating an example of anonymized movement history data.

FIG. 13 is a diagram illustrating a configuration example of a computer to which the present method is applied.

### DESCRIPTION OF EMBODIMENTS

Hereinbelow, embodiments of the present invention will be described. Note that, in the drawings to be used in the description below, components having the same functions or steps for performing the same processing will be labeled with the same reference signs, and description thereof will not be repeated.

### Points of First Embodiment

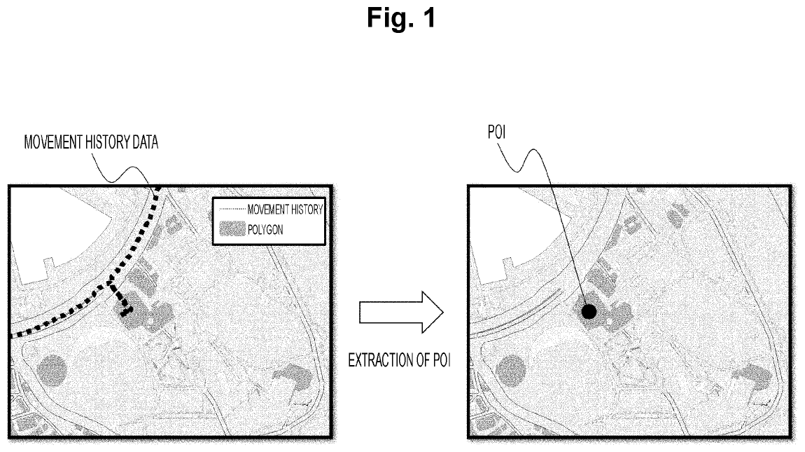

FIG. 1 is a diagram for describing an overview of the present embodiment. In the present embodiment, only POI information required for an analysis purpose is extracted from trajectory (movement history) data of location information acquired and accumulated from an automobile having a communication function, and is converted into facility name information.

By using only data of POI information, uniqueness can significantly be reduced. In addition, according to the present embodiment, structured data can be obtained. The structured data is to describe information according to a certain rule (structure) and add meaning to the data. Note that various methods for anonymizing structured data have been proposed, and a method not only for location information can be applied. In this manner, it is possible to obtain POI information in accordance with an analysis purpose.

The present embodiment is invented focusing on the nature of a movement history acquired from an automobile.

Until now, most studies have been conducted on a movement history acquired from a smartphone, and since the smartphone is always carried, the user's entire life is acquired from the location information.

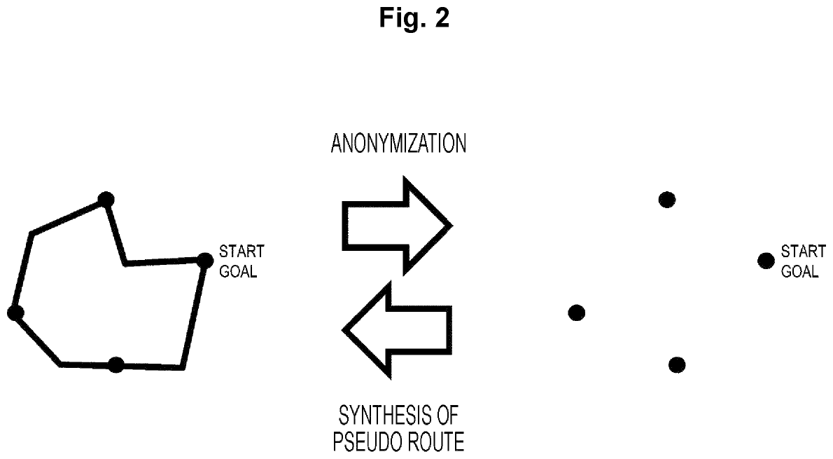

On the other hand, an automobile has a strong aspect as a means used for the purpose of “moving to a destination”. For this reason, in a movement history acquired from an automobile, an optimum (shortest) route is often selected for selection of a movement route to a clear destination (POI), and if the POIs can be obtained correctly, all movement routes can be obtained as synthesized data in a pseudo manner by adding the optimum routes as dummy data between the POIs. FIG. 2 is a diagram for describing anonymization and synthesis of a pseudo route.

Here, the differences between the smartphone and the automobile in the nature of the movement history acquired therefrom will be described.

1. Moving method: In the case of the smartphone, since all options such as walking, bicycle, automobile, bus, and railway are conceivable, the moving method cannot be specified. On the other hand, in the case of the automobile, the moving method is limited only to automobile.

2. Situation at time of acquisition: In the case of the smartphone, since all situations such as movement, work, leisure, and travel are conceivable, the situation at the time of acquisition cannot be specified. On the other hand, in the case of the automobile, the situation at the time of acquisition is limited to movement while driving the automobile.

3. Geographic range: In the case of the smartphone, all places such as land, sea, and air, the inside of a building, a forest, and a mountain are conceivable, and the radio waves cannot specify the geographic range. On the other hand, in the case of the automobile, the geographical range is limited to a range in which the automobile can travel. In addition, in the case of the automobile, the geographical range is also limited in terms of transportation.

4. Acquisition trigger and frequency: In the case of the smartphone, since the acquisition is performed when a location information service is used, and the frequency varies depending on the service, the acquisition trigger and frequency cannot be specified. On the other hand, in the case of the automobile, the acquisition is performed at a certain frequency when the engine is driven.

In general, the movement history data acquired from the automobile is simpler than the movement history data acquired from the smartphone. Anonymization suitable for such nature of the data is required. Noise addition, dummy addition, and the like in the conventional art may impair the utility. Also, at the time of generalization, in a case where the geographic range is wide, the data may be unique and have an increased risk of identifying an individual, whereas significant generalization may lead to a decrease in utility.

In the present embodiment, anonymization is performed while maintaining utility without performing noise addition or dummy addition.

### First Embodiment

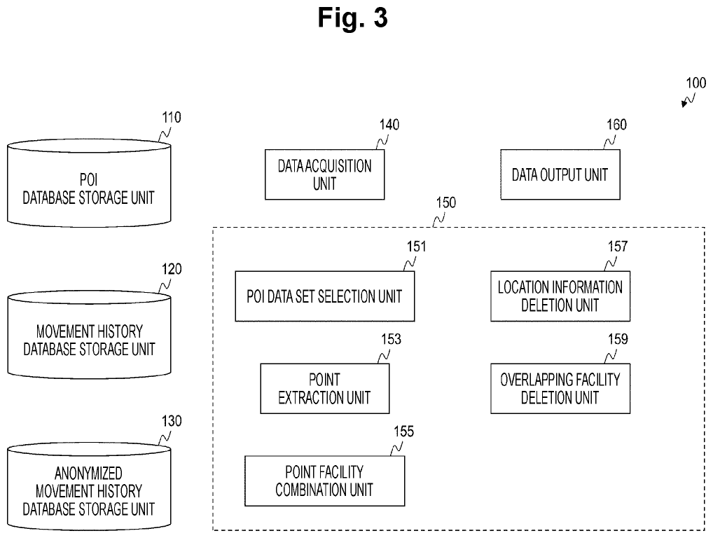

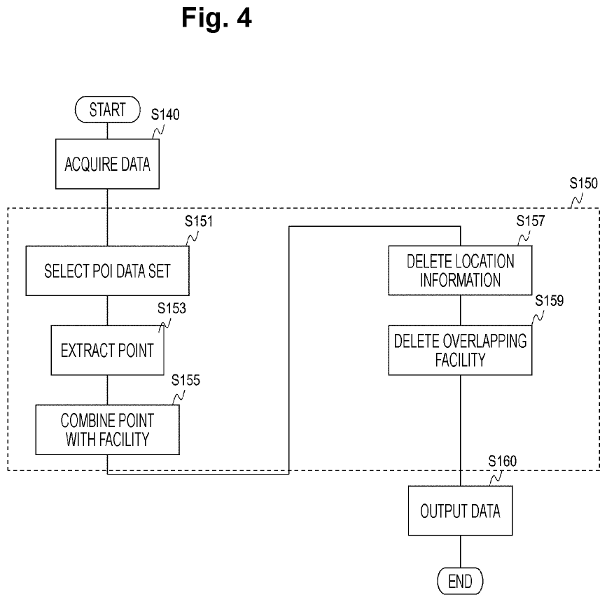

FIG. 3 is a functional block diagram of an anonymization device according to a first embodiment, and FIG. 4 illustrates a processing flow thereof.

The anonymization device 100 includes a POI database storage unit 110, a movement history database storage unit 120, an anonymized movement history database storage unit 130, a data acquisition unit 140, an anonymization processing unit 150, and an output unit 160. The anonymization processing unit 150 includes a POI data set selection unit 151, a point extraction unit 153, a point facility combination unit 155, a location information deletion unit 157, and an overlapping facility deletion unit 159.

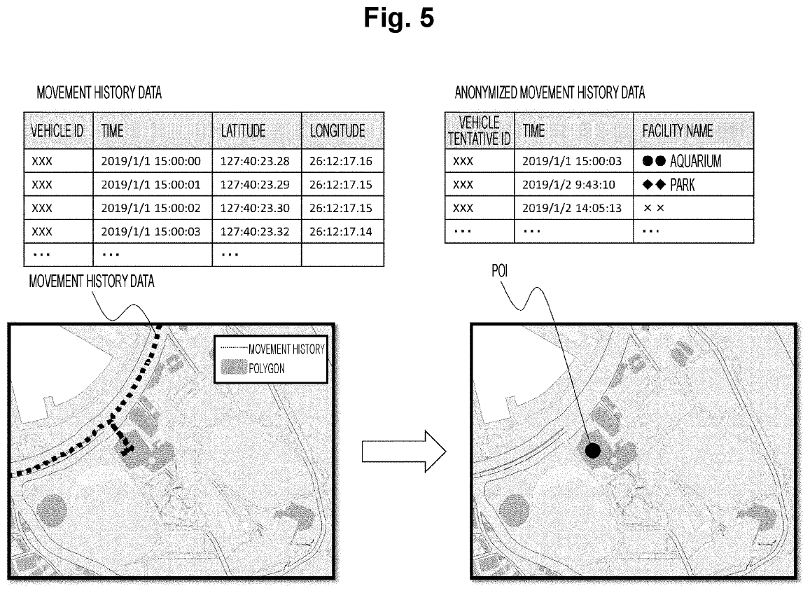

The anonymization device 100 receives movement history data as an input, performs anonymization processing, and outputs anonymized movement history data. FIG. 5 illustrates examples of movement history data and anonymized movement history data.

The anonymization device 100 is a special device configured such that a special program is loaded into a known or dedicated computer including, for example, a central processing unit (CPU), a main storage device (random access memory (RAM)), and the like. The anonymization device 100 executes each of pieces of processing under control of the central processing unit, for example. Data input into the anonymization device 100 and data obtained in each of the pieces of processing are stored in, for example, the main storage device, and the data stored in the main storage device is read to the central processing unit as necessary and used for other processing. At least some of the processing units of the anonymization device 100 may be configured by hardware such as an integrated circuit. Each of the storage units included in the anonymization device 100 can be configured by, for example, a main storage device such as a random access memory (RAM) or middleware such as a relational database and a key value store. Note, however, that each of the storage units is not necessarily provided inside the anonymization device 100. Each of the storage units may be configured by an auxiliary storage device including a hard disk, an optical disk, or a semiconductor memory device such as a flash memory, and may be provided outside the anonymization device 100.

Each of the units will be described below.

### <Data Acquisition Unit 140 and Movement History Database Storage Unit 120>

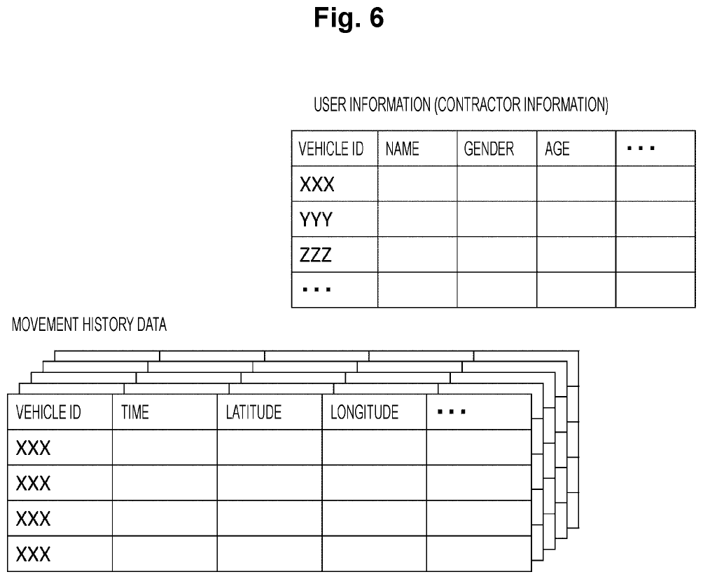

The data acquisition unit 140 receives movement history data as an input, and stores the movement history data in the movement history database storage unit 120 (S120). FIG. 6 illustrates an example of movement history data.

The movement history data is time-series data having location information (for example, latitude and longitude) and time as essential attributes, and is acquired and accumulated for each vehicle. Further, as the movement history data, attributes other than the above-described essential attributes may be acquired and accumulated, but are not set as processing targets in the present embodiment. For example, the movement history data may be associated with user information by a vehicle ID. The movement history data is acquired from an automobile as described above. Although the movement history data is acquired at intervals of several tens of seconds to 1 second at present, but will be acquired at a very high frequency of 60 Hz at the maximum in the future. For example, the movement history data is acquired from an automobile using a location information acquisition device (for example, a car navigation system using GPS) mounted on the automobile and having a communication function.

### <POI Database Storage Unit 110>

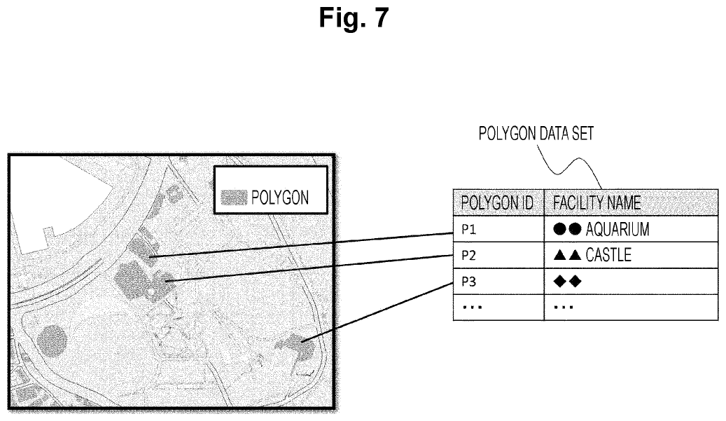

Prior to anonymization, one or more polygon data sets are stored in the POI database storage unit 110. FIG. 7 illustrates an example of a polygon data set. Note that one polygon data set includes a plurality of pieces of polygon data, and the polygon data is data in which a facility serving as an analysis target is represented by a polygon. The polygon data set is created in advance in accordance with an analysis purpose.

A site of a certain facility including the parking lot is set as one piece of polygon data, and the polygon data is associated with facility name data. The polygon data is only required to be information indicating a site of a certain facility including the parking lot, and may be, for example, information indicating a boundary between the inside and the outside of the site of the certain facility including the parking lot, or may be a set of all positions included in the site of the certain facility including the parking lot.

A plurality of pieces of polygon data are collected in accordance with an analysis purpose to obtain a polygon data set. For example, a “tourist facility” data set, a “restaurant” data set, an “expressway SA and PA” data set, and the like are conceivable. For the creation of the polygon data set, use of software such as a geographic information system (GIS) can be assumed.

### <Anonymization Processing Unit 150 and Anonymized Movement History Database Storage Unit 130>

The anonymization processing unit 150 takes out target movement history data from the movement history database storage unit 120, performs anonymization processing (S150), and stores the anonymized movement history data in the anonymized movement history database storage unit 130. Hereinbelow, processing of each unit included in the anonymization processing unit 150 will be described.

### <POI Data Set Selection Unit 151>

The POI data set selection unit 151 selects one of the one or more polygon data sets stored in the POI database storage unit 110 (S151). For example, the POI data set selection unit 151 displays one or more data sets such as the “tourist facility” data set, the “restaurant” data set, and the “expressway SA and PA” data set on a not-illustrated display unit to prompt the user of the anonymization device 100 to select any of the data sets. The user selects any data set via a not-illustrated input unit, and the POI data set selection unit 151 selects the data set selected by the user.

### <Point Extraction Unit 153>

The point extraction unit 153 takes out target movement history data from the movement history database storage unit 120, refers to the polygon data set selected by the POI data set selection unit 151, extracts the movement history data inside the polygon included in the polygon data set (S153), and outputs the movement history data. Note that the movement history data outside the polygon is deleted. Hereinbelow, the extracted movement history data is also referred to as a point.

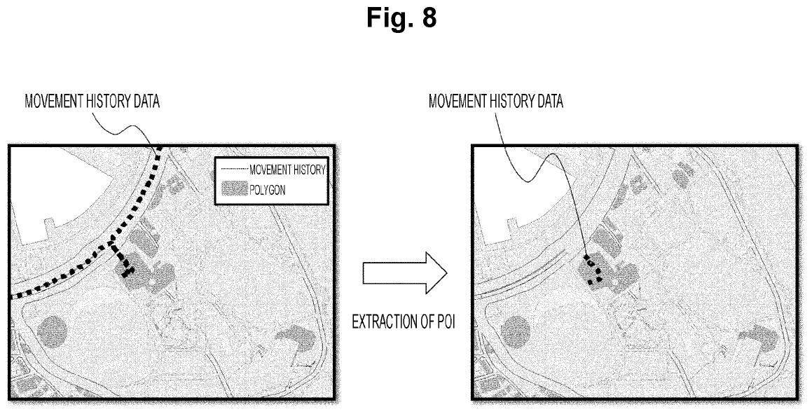

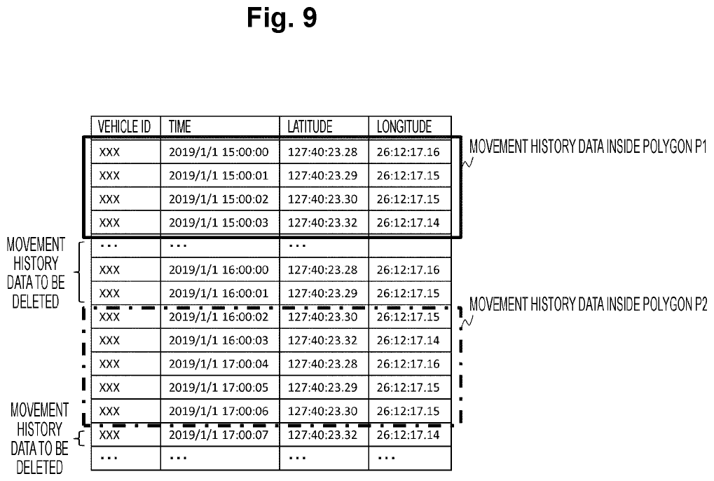

For example, FIG. 8 is a diagram for describing the procedure of extracting movement history data inside a polygon included in a polygon data set, and FIG. 9 is a diagram for describing an example of extraction and deletion from movement history data taken out from the movement history database storage unit 120.

### <Point Facility Combination Unit 155>

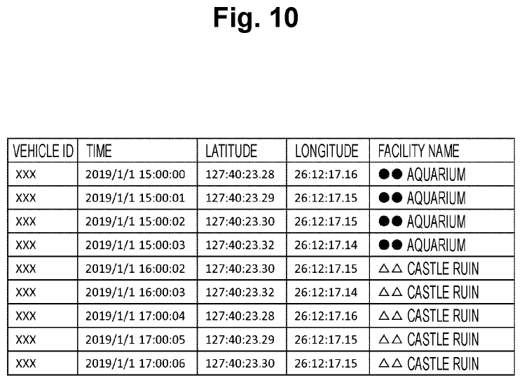

The point facility combination unit 155 receives a point as an input, combines facility name data of the polygon data including the point with the point (S155), and outputs combined data. FIG. 10 illustrates an example of data output from the point facility combination unit 155.

### <Location Information Deletion Unit 157>

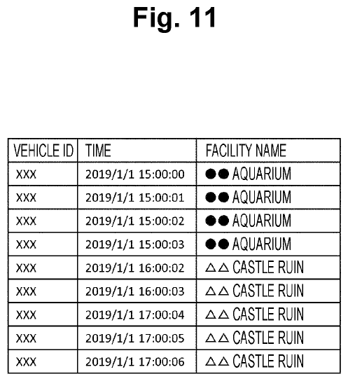

The location information deletion unit 157 receives the point combined with the facility name data as an input, deletes the location information (for example, latitude and longitude) (S157), and outputs data. FIG. 11 illustrates an example of data output from the location information deletion unit 157.

### <Overlapping Facility Deletion Unit 159>

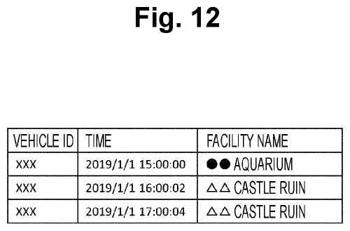

The overlapping facility deletion unit 159 receives the data output from the location information deletion unit 157 as an input, deletes points having overlapping facility names (S159) to obtain anonymized movement history data, and stores the anonymized movement history data in the anonymized movement history database storage unit 130. For example, the overlapping facility deletion unit 159 reserves one of the points having overlapping facility names and deletes the remaining points. The reserved point is also referred to as a representative point. FIG. 12 illustrates an example of data (anonymized movement history data) output from the overlapping facility deletion unit 159.

A plurality of deletion methods can be considered depending on the purpose, but simply, only the line with the earliest time is reserved and the others are deleted. Also, in a case where the time interval is equal to or less than a specified threshold value, it is determined as one visit, and in a case where the time interval is equal to or more than the specified threshold value, the visits before and after the time interval equal to or more than the specified threshold value are determined as different visits, and representative points are obtained before and after the time interval, respectively.

### <Output Unit 160>

In response to the request of the user of the anonymization device 100, the output unit 160 takes out the anonymized movement history data from the anonymized movement history database storage unit 130 and outputs the anonymized movement history data to the not-illustrated display unit (S160), and the display unit displays the anonymized movement history data.

### <Effects>

With the above configuration, it is possible to anonymize a movement history while maintaining the utility required for analysis without impairing the value of the movement history.

### Modification Examples

In the present embodiment, the anonymized movement history data includes time information. Therefore, the uniqueness of the data remains. In order to remove this uniqueness, time information is deleted or generalized. However, how to treat the time information differs depending on the analysis purpose and the data volume.

For example, conceivable as an example of the treating method is to delete all the time information to form a simple combination of visited facilities instead of time-series data.

Also, the more the information with finer granularity exists, the more the uniqueness remains, and thus, this feature is taken into consideration. In the example of FIG. 12, the granularity is finer in the order of year, month, day, hour, minute, and second. Therefore, conceivable is a method of deleting information in ascending order of granularity (order of second, minute, hour, day, month, and year) until sufficient security can be ensured. Also, the information may be rounded at predetermined time intervals. For example, the information may be rounded to [0 to 3] [3 to 6] [6 to 9] . . . every 3 hours, or the months may be rounded to seasons of spring, summer, fall, and winter.

Also, conceivable is a method of deleting year, month, and day and generalizing the information by means of time zones.

Note that, as a method of anonymizing the time information, an existing method can be used depending on the analysis purpose and the data volume instead of the above-described methods.

### Expected Use Example: Rental Car Use Data on Remote Island

Here, the movement history data acquired and accumulated by use of a rental car on a remote island is anonymized by the proposed method. The value of such data is very high, and for example, it is conceivable that more detailed analysis is performed by associating the data with attribute information of the user, and the data is utilized for marketing, service provision suitable for the users, or the like. For example, it is assumed that the use of a rental car on a remote island has the following features.
Needs for tourism use are very large, and therefore the ratio of uses for purposes other than tourism (for example, moving and driving) is small.
Since it is a remote island, there is almost no use across prefectures.
The movement history is separated from the living area of the user, the user moves from one tourist spot to another (in a more optimum route), and the accumulation period is several days at the longest.

### Other Modification Examples

The present invention is not limited to the foregoing embodiments and modification examples. For example, various kinds of processing described above may be executed not only in time series in accordance with the description but also in parallel or individually in accordance with processing abilities of the devices that execute the processes or as necessary. Further, modifications can be made as needed within the gist of the present invention.

### <Program and Recording Medium>

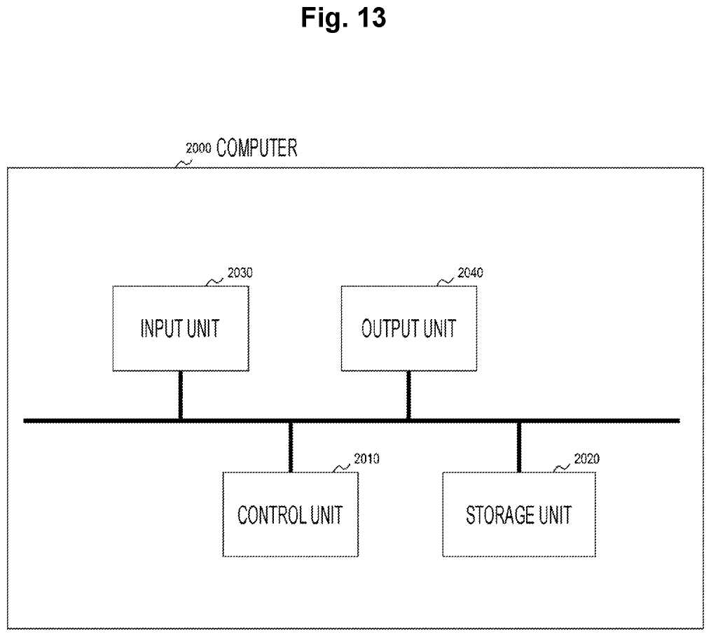

Various kinds of processing described above can be carried out by causing a storage unit 2020 of a computer illustrated in FIG. 13 to load a program for executing each step of the method described above and causing a control unit 2010, an input unit 2030, an output unit 2040, and the like, to operate.

The program in which the processing content is written can be recorded in a computer-readable recording medium. The computer-readable recording medium may be, for example, any recording medium such as a magnetic recording device, an optical disk, a magneto-optical recording medium, and a semiconductor memory.

Also, distribution of the program is performed by, for example, selling, transferring, or renting a portable recording medium such as a DVD and a CD-ROM on which the program is recorded. Further, a configuration in which the program is stored in a storage device in a server computer and the program is distributed by transferring the program from the server computer to other computers via a network may also be employed.

For example, the computer that executes such a program first temporarily stores the program recorded in the portable recording medium or the program transferred from the server computer in its own storage device. Then, when executing processing, the computer reads the program stored in its own recording medium and executes processing in accordance with the read program. As another mode of executing the program, the computer may directly read the program from the portable recording medium and execute processing in accordance with the program, or, every time the program is transferred from the server computer to the computer, the computer may sequentially execute processing in accordance with the received program. Alternatively, the above processing may be performed by a so-called application service provider (ASP) service that implements a processing function only by issuing an instruction to perform the program and acquiring the result, without transferring the program from the server computer to the computer. Note that the program in this mode includes information that is used for processing by an electronic computer and is equivalent to the program (data or the like that is not a direct command to the computer but has a property that defines processing of the computer).

Although the present device is configured by executing a predetermined program on a computer in the present embodiment, at least part of the processing content may be implemented by hardware.

1. An anonymization device comprising:
storing, in a database, a polygon data set serving as a set of polygon data associated with facility name data and indicating a site of a facility;
extracting movement history data inside a polygon included in the polygon data set from target movement history data, the movement history data being time-series data including location information and time and being acquired for a vehicle;
combining, using the database, facility name data of polygon data including the extracted movement history data with the extracted movement history data;
deleting the location information of the movement history data combined with the facility name data; and
deleting the movement history data having overlapping facility names from the movement history data from which the location information has been deleted to obtain anonymized movement history data.

2. The anonymization device according to claim 1, wherein time information in the anonymized movement history data is deleted.

3. A computer implemented method for anonymizing data, comprising:
extracting movement history data inside a polygon included in a polygon data set from target movement history data, the movement history data being time-series data including location information and time and being acquired for a vehicle;
combining, by using a database, facility name data of polygon data including the extracted movement history data with the extracted movement history data, wherein the database stores the polygon data set serving as a set of polygon data associated with the facility name data and indicating a site of a facility;
deleting the location information of the movement history data combined with the facility name data; and
deleting the movement history data having overlapping facility names from the movement history data from which the location information has been deleted to obtain anonymized movement history data.

4. The anonymization method according to claim 3, wherein
time information in the anonymized movement history data is deleted.

5. A computer-readable non-transitory recording medium storing a computer-executable program instructions that when executed by a processor cause for a computer to execute operations comprising:
storing, in a database, a polygon data set serving as a set of polygon data associated with facility name data and indicating a site of a facility;
extracting movement history data inside a polygon included in the polygon data set from target movement history data, the movement history data being time-series data including location information and time and being acquired for a vehicle;
combining, using the database, facility name data of polygon data including the extracted movement history data with the extracted movement history data;
deleting the location information of the movement history data combined with the facility name data; and
deleting the movement history data having overlapping facility names from the movement history data from which the location information has been deleted to obtain anonymized movement history data.

6. The anonymization device according to claim 1, wherein time information in the anonymized movement history data is generalized.

7. The anonymization device according to claim 1, wherein the set of polygon data indicates a site of a parking lot.

8. The anonymization device according to claim 1, wherein the set of polygon data indicates a site of a restaurant.

9. The anonymization method according to claim 3, wherein time information in the anonymized movement history data is generalized.

10. The anonymization method according to claim 3, wherein the set of polygon data indicates a site of a parking lot.

11. The anonymization method according to claim 3, wherein the set of polygon data indicates a site of a restaurant.

12. The computer-readable non-transitory recording medium according to claim 5, wherein time information in the anonymized movement history data is deleted.

13. The computer-readable non-transitory recording medium according to claim 5, wherein time information in the anonymized movement history data is generalized.

14. The computer-readable non-transitory recording medium according to claim 5, wherein the set of polygon data indicates a site of a parking lot.

15. The computer-readable non-transitory recording medium according to claim 5, wherein the set of polygon data indicates a site of a restaurant.
